(19) United States
(12) Patent Application Publication
(10) Pub. No.: US 2010/0011929 A1
(43) Pub. Date: Jan. 21, 2010

(54) POWER-SAW CROSS-CUT, MITER-CUT, AND RIP-CUT ASSEMBLY

(76) Inventor: Joseph IANNELLI, SR., St. Cloud, FL (US)

Correspondence Address: ROBERT M. MCDERMOTT, ESQ., 1824 FEDERAL FARM ROAD, MONTROSS, VA, 22520, US

(21) Appl. No.: 12/275,197

(22) Filed: Nov. 20, 2008

Related U.S. Application Data
(60) Provisional application No. 61/081,385, filed on Jul. 16, 2008.
(60) Provisional application No. 61/097,855, filed on Sep. 17, 2008.

(51) Int. Cl. B26D 1/14; B26D 5/08

(52) U.S. Cl. 83/471.3; 83/581

(57) ABSTRACT

A platform extends over a work surface and includes a circular opening across which a circular-saw support frame extends. The circular-saw support frame is adjustable to accommodate the sole plate of any of a variety of models of circular-saws. The platform is supported above the work surface by support elements arranged at the corners of the platform, allowing the workpiece to be inserted from any direction. Because the saw support frame is supported at both ends by the platform, the torque forces associated with a cantilevered radial arm saw structure are avoided. The apparatus also includes a base that forms the work surface and includes a drawer for holding tools or parts. The drawer is preferably partitioned and configured to capture a substantial portion of the sawdust that is produced by the cutting. The apparatus also includes a removable and adjustable fence that facilitates accurate and precise rip-cuts.

This application claims the benefit of U.S. Provisional Patent Applications 61/081,385 filed 16 Jul. 2008 and 61/097,855, filed 17 Sep. 2008.

### BACKGROUND AND SUMMARY OF THE INVENTION

This invention relates to the field of power tools, and in particular to a support assembly that facilitates the use of a common hand-held power saw for accurate and efficient cross-cut, miter and rip-cuts.

Radial arm saws and/or table saws are commonly used by woodworkers and carpenters to cut lumber, board material, and molding at a variety of angles. With regard to lumber and boards, the longer dimension is typically the dimension that runs with the grain of the piece, and is conventionally termed the length of the piece. With regard to sheet material, such as plywood or pressed board, the longer dimension is typically termed the length, regardless of the grain, if any. If a cut is made perpendicular to the run of the grain, or the longer dimension, it is termed a “cross-cut”; if the cut is parallel to the grain, or the longer dimension, it is termed a “rip-cut”; if the cut is neither perpendicular nor parallel to the longer dimension, it is termed a “miter-cut”. If the cut is not perpendicular to the thickness of the piece, it is termed a “bevel-cut”, and if a miter-cut is also not perpendicular to the thickness of the piece, it is termed a “compound-cut”.

Radial arm saws and table saws are special purpose tools that include an integral saw motor and blade assembly and components that facilitate aligning or orienting the saw-blade with the workpiece to produce a cut at the desired simple or compound angle.

Chop-saws and compound-miter saws are also special purpose tools with an integral saw motor and blade assembly and components that align and orient the saw blade to facilitate accurate and efficient cutting of wood, but, because the saw only moves in the vertical (“chop”) direction, the size of the cut, and hence the size of the material that can be cut, is limited to the size of the saw blade.

A hand-held power saw (hereinafter circular-saw), on the other hand, is a general purpose tool, comprising merely a motor and circular blade assembly with a handle. A conventional circular-saw includes a sole-plate that rests upon the workpiece as the saw travels along the workpiece. The orientation of the saw blade can be adjusted relative to the sole plate, to allow for cuts at varied angles relative to the thickness of the workpiece. Lacking lateral-alignment components, the circular-saw can be laterally oriented with regard to the workpiece at any angle, and can traverse workpieces of any dimension.

Although professional and semi-professional woodworkers will likely have a sufficient need to warrant the purchase of each of the aforementioned types of saws, most homeowners/DIY-ers (Do-It-Yourself-ers) or odd-job contractors will likely only be able to rationally justify the purchase of a simple circular-saw, do to the relatively infrequent use of the tool.

Because of the lack of alignment components, however, circular-saws do not provide for the accuracy and precision that is achievable by radial-arm saws, table saws, and chop/compound-miter saws.

Although the relative usage of a circular-saw may be infrequent for a typical homeowner or odd-job contractor, when the need for the power-saw arises, the user may also need accuracy and precision. That is, for example, although a typical homeowner may not frequently use a circular-saw to cut molding, when the homeowner is engaged in a project that involves the installation of molding, the homeowner would like to be able to make accurate miter cuts. In like manner, when the homeowner has an occasion to make a cabinet or bookcase, the homeowner would like to make accurate cross-cuts and rip-cuts.

A number of prior-art devices have been designed to facilitate precision cuts using a circular-saw. In the simplest case, a simple straight-edge device with an edge that is thick enough to allow alignment of the circular-saw's sole plate can be clamped to the workpiece, but such a solution is rather cumbersome, and impractical for short dimension cuts, such as cross-cuts of lumber and miter-cuts of molding.

U.S. Pat. No. 4,519,280, “MITER BOARD AND SAW GUIDE”, issued 28 May 1985 to Carl E. Cook, and incorporated by reference herein, discloses a work surface that includes a pivotable track assembly that supports a circular-saw and allows the saw to make cuts at 90° and ±45° relative to a rear fence piece. The track assembly is adjustable to allow for different models of circular-saws, and includes a “keeper” that prevents the saw from jumping out of the track. For miter cuts at different angles, a fence piece can be clamped to the work surface and oriented to the angle of travel of the circular-saw, the short-edge of the workpiece being placed against the fence piece to make the cut. In Cook's embodiment, the accuracy of placing the fence piece, as well as the orthogonality of the edge of the workpiece, determines the accuracy of the resultant cut. The configuration of Cook's embodiment also precludes rip-cuts, and requires an orthogonal cut at the end of the piece before the miter-cut can be made. That is, a miter-cut cannot be made at a desired point along the length of the piece until an orthogonal cut is first made at that point.

U.S. Pat. No. 4,840,097, “PORTABLE MITER GUIDE DEVICE FOR PORTABLE POWER SAWS”, issued 20 Jun. 1989 to Erwin D. Campbell, and incorporated by reference herein, discloses an apparatus that is placed atop a work surface and includes an adjustable track assembly that is pivotable relative to a fence that is placed against the workpiece. The track assembly is pivotable to any angle between about ±60°, allowing for accurate miter cuts at any point along the length of the workpiece, but does not provide for rip-cuts.

U.S. Pat. No. 6,116,304, “POWER TOOL GUIDE ASSEMBLY”, issued 12 Sep. 2000 to Wilson et al., and incorporated by reference herein, discloses a circular-saw support frame that is stationary, and the fence is adjusted to provide for miter cuts. Because of the asymmetric relationship of the miter fence relative to the frame, the range of miter cuts is limited; and, rip-cuts are not possible.

U.S. Pat. No. 5,179,886, “RADIAL BEAM ARM SAW TABLE”, issued 19 Jan. 1993 to Marvin E. Rathje, Jr., and incorporated by reference herein, discloses an apparatus that allows for mounting a circular-saw on a frame that is similar to a conventional radial arm saw frame. As in a conventional radial arm saw, the support structure cantilevers the saw above the work surface, introducing a significant amount of torque to the upright and extension segments of the structure. Accordingly, the structure must be sufficiently strong/massive to avoid deflections that will affect the orthogonality of the blade to the workpiece, and of sufficient mass so as to avoid tipping of the structure when the circular-saw is maximally extended. Given this requirement for a substantial structure to support the circular-saw, the cost of this apparatus is likely to approach that of a conventional radial arm saw.

U.S. Pat. No. 6,484,767, “POWER TOOL GUIDE AND WORK CENTER”, issued 26 Nov. 2002 to Alan B. H. Cameron, and incorporated by reference herein, discloses a circular-saw support frame that is supported by posts that are movable within tracks parallel to a fence to adjust the angle of the track relative to the fence. In this configuration, the posts preclude rip-cuts. Additionally, the lateral adjustment of the posts to achieve a desired angle does not facilitate accurate adjustments to a desired angle relative to the fence.

USPA 2003/0145706, “GUIDE FOR POWER TOOL”, published 7 Aug. 2003 for Bobby Jordan, and incorporated by reference herein, discloses a light weight circular-saw support frame that facilitates cross-cuts only.

U.S. Pat. No. 6,715,391, “DEVICE FOR SECURING VARIOUS TABLE SAWS TO WORK TABLE”, issued 6 Apr. 2004 to Tian Wong Wang, and incorporated by reference herein, discloses an apparatus for supporting a circular-saw on a frame that is similar to a conventional radial arm saw frame. As discussed above, the cantilevering of the saw over the work surface introduces a structural cost that approaches the cost of a conventional radial arm saw.

U.S. Pat. No. 6,991,009, “WORK SURFACE GUIDE FOR POWER TOOLS”, issued 31 Jan. 2006 to William Wedeward, and incorporated by reference herein, discloses a fixed-height structure that attaches to an edge of a work surface and allows for cross-cuts and miter-cuts by adjusting a pivotable fence that extends down from the structure. The circular-saw is cantilevered beyond the work surface, necessitating a well structured attachment and support to the work surface.

As the above analysis demonstrates, the radial arm saw devices provide all of the functionality of a radial arm saw with regard to cross-cut, miter-cut, and rip-cut capabilities, but require substantial structures to reliably support the cantilevered circular-arm saw so that the blade remains orthogonal to the work surface over time. Each of the other non-cantilevered devices has limited functionality with regard to cross-cut, miter-cut, and rip-cut capabilities, and/or accurate miter-cut adjustments.

It would be advantageous to provide a support structure for a circular-saw that allows the saw to be used for cross-cuts, miter-cuts, and rip-cuts. It would also be advantageous to provide this structure without the structural requirements imposed by a cantilevered structure.

These advantages, and others, can be realized by a platform that extends over the work surface and includes a circular opening across which a circular-saw support frame extends. In a preferred embodiment, the platform is supported above the work surface at each of its four corners. Because the saw support frame is supported at both ends by the platform, the torque forces associated with a cantilevered structure are avoided. Also in a preferred embodiment, the apparatus includes a base that forms the work surface and includes a drawer for holding tools or parts. The drawer is preferably partitioned and configured to capture a substantial portion of the sawdust that is produced by the cutting. The apparatus also includes a removable and adjustable fence that facilitates accurate and precise rip-cuts.

### BRIEF DESCRIPTION OF THE DRAWINGS

The invention is explained in further detail, and by way of example, with reference to the accompanying drawings wherein:

FIGS. 1A-1E illustrates an example embodiment of a miter assembly for a power saw in accordance with this invention.

FIGS. 2A-2C illustrate example embodiments of a base unit for a miter assembly in accordance with this invention.

FIG. 3 illustrates an example embodiment of a drawer unit for a miter assembly in accordance with this invention.

FIGS. 4A-4B illustrate an alternative embodiments of a guide assembly in accordance with this invention.

FIGS. 5A-5C illustrate an alternative embodiment of a base unit in accordance with this invention.

FIG. 6 illustrates a base unit with an extendable support in accordance with this invention.

Throughout the drawings, the same reference numerals indicate similar or corresponding features or functions. The drawings are included for illustrative purposes and are not intended to limit the scope of the invention.

### DETAILED DESCRIPTION

In the following description, for purposes of explanation rather than limitation, specific details are set forth such as the particular architecture, interfaces, techniques, etc., in order to provide a thorough understanding of the concepts of the invention. However, it will be apparent to those skilled in the art that the present invention may be practiced in other embodiments, which depart from these specific details.

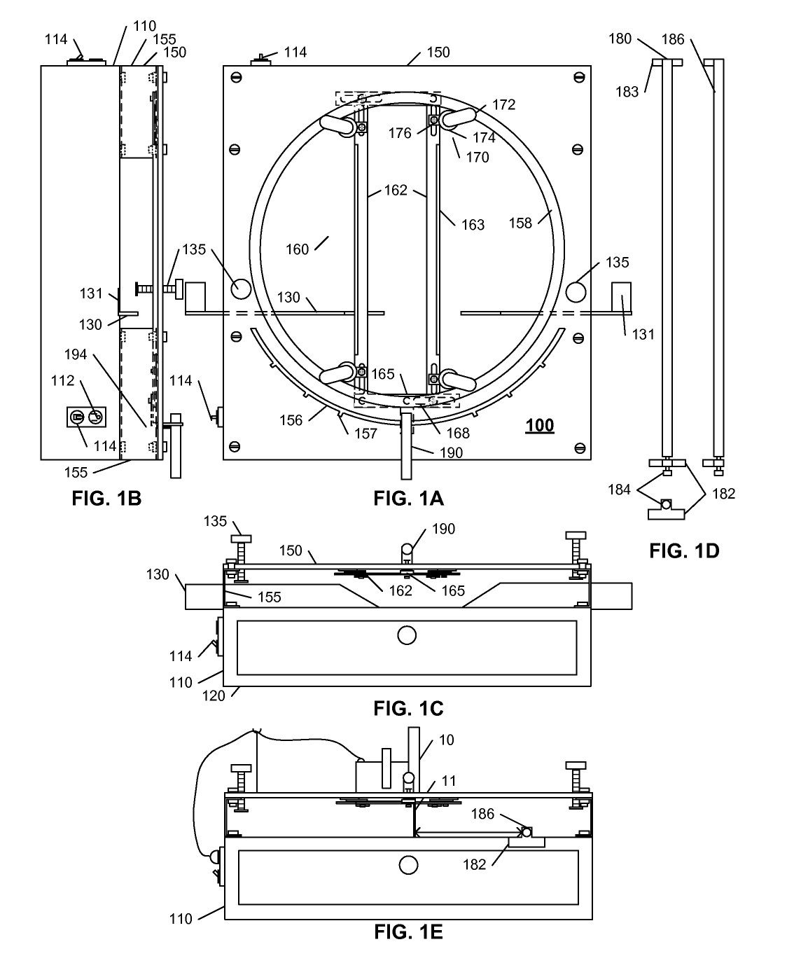

FIG. 1A illustrates a top view, FIG. 1B illustrates a side view, and FIG. 1C illustrates a front view of a miter assembly 100 in accordance with this invention. FIG. 1D illustrates a rip fence component of the miter assembly, and FIG. 1E illustrates a front view of the miter assembly with the rip fence installed. The assembly 100 includes a base unit 110 and a support platform 150 that is configured to support a conventional circular-saw 10.

The support platform 150 includes a substantially circular opening within which a rotatable guide assembly 160 is mounted. The guide assembly 160 includes guide rails 162 that provide a surface for supporting the base of the circular-saw, and cross members 165 that couple the guide rails.

Because the miter assembly 100 is designed for use with various models of circular-saws, each guide rail 162 is coupled to a cross member 165 via a slot 168 that allows the guide rails 162 to be appropriately spaced apart such that the base of the circular-saw fits snugly between the alignment guides 163 on each rail 162.

The guide assembly 160 can be oriented at varying angles within the circular opening of the support platform 150. A guide handle 190 above the platform 150 is coupled to the guide assembly 160 beneath the platform via an angled bracket that passes through an arc-shaped slot 156 in the platform 150. A printed guide (not illustrated) on the platform 150 serves to indicate the angle of the assembly 160 relative to a reference position of the guide assembly. Conventionally, the reference position is a position such that the travel of the saw blade is perpendicular to a guide fence 130 used to make cross-cuts. This reference position is termed 0°, and angles on either side are referenced by the number of degrees of rotation of the guide assembly 160 clockwise or semi-clockwise from this reference position.

In a preferred embodiment, radial slots 157 are provided in the slot 156, into which a tab 194 beneath the handle 190 may extend, via a spring-tension assembly. These radial slots are provided at commonly used carpentry miter angles, such as 0°, 22.5°, 37.5°, and 45°, to lock the assembly in place at the desired angle.

Any of a variety of techniques can be used to support the assembly 160 within the circular opening of the platform 150. As illustrated in FIG. 1A, support assembly 170 is configured to be coupled to the guide assembly 160 below the surface of the platform 150 and includes a tongue 172 that is configured to rest upon the upper surface of the platform 150, preferably within a support groove 158. As illustrated, the coupling of the support assembly 170 to the guide assembly 160 is via slots 176 that allow for adjustments as the width of the assembly 160 is varied to accommodate the size of the base of the particular saw being used.

In an alternative embodiment, the support assemblies 170 are coupled to the fixed-length cross members 165, minimizing the need for adjustment as the space between the rails 162 is varied. Circular bearings 174 allow for a snug fit of the assembly within the circular opening of the platform 150 while still allowing the assembly 160 to rotate within the opening. Alternatively, or additionally, if the support groove 158 is channeled, the tongue 172 could include a bearing that rides within the channel of the groove 158.

One of skill in the art will recognize that the size of the assembly 100 will depend upon its intended application. The following figures are considered typical, but the principles of this invention are not limited to these dimensions. The guide rails 162 should be adjustable to support saws with bases that range from 3-7″, although 4-6″ will accommodate the most popular saws.

The length of the rails is only limited by the choice of materials used to span the gap without flexing. Preferably, the length should allow for about 18″ of travel of the saw, although as little as 10″ would generally be suitable for mitering typically sized molding or planking lumber. Accordingly, the platform 150 will generally be at least 20″ long, and typically 30-36″ long. The width will typically be somewhat less than the length, determined by the permitted range of angles of the assembly 160, typically at least 45° and often as much as 60°.

Preferably, the assembly 100 includes an integral base unit 110, although the platform 150 can be provided for use on any surface suitably configured to support a workpiece at an appropriate orientation relative to the platform 150.

The elevation/height of the platform 150 above the base unit 110 is set by the size of C-channel support elements 155 that couple the platform 150 to the base unit 110. The height of the support element 155 is set based on the anticipated use of the assembly 100. If the assembly 100 is designed primarily for trim moldings, the height may be as small as 1″; if the assembly 100 is designed for general-purpose use, the height is preferably greater than 1½″, and limited only by the expected maximum extent of the blade of a typical circular-saw, a smaller saw blade requiring a lesser height.

Optionally, the assembly 100 may be marketed with a set of differently sized support elements 155, based on the size/extent of the blade in the particular circular-saw being used, as well as the anticipated thickness of the workpieces, and/or the likelihood of bevel cuts for a given project. Optionally, the support elements 155 may be replaced by adjustable-height support posts, to facilitate the different requirements for differing thicknesses of the workpiece, and/or different anticipated bevel angles.

As illustrated, each of a pair of guide fence units 130 is configured to be inserted into a slot in the base unit 110, and includes a ledge piece 131 that further extends the support provided by the base unit 110. Also illustrated, in a preferred embodiment, the platform 150 includes a pair of clamping screws 135 that allow the workpiece to be clamped to the base unit 110, aligned with the fence units 130. These clamping screws 135 are also situated so that they can be used to hold the fence units 130 in place for storage or travel, by clamping the ledge piece 131 when the fence units 130 are inserted further into the base unit 110. As illustrated, the fence units 130 may optionally be tapered to facilitate maximum fence support for bevel cuts.

Although the fence units 130 are illustrated as being shorter than the height of the support platform 150 above the base unit 110, one of skill in the art will recognize that the fence units 130 could extend to the full height, and the support platform 150 could also include a slot on its underside for receiving the top edge of the fence units 130.

By providing an integral base unit 110, features such as a drawer 120, and an electrical outlet 112 may be provided. Power to the outlet 112 is provided by a pig-tail plug for connection to a conventional power outlet, and is preferably controlled by a switch 114, to allow for emergency shut-off of the power saw that is plugged into the outlet. The configuration of the switch and outlet may take on any of a variety of forms, including, for example, a fixed-location switch and a pig-tail outlet suspended above the platform 150. In a preferred embodiment, at least a second switch 114 is provided, at another side of the base unit 110 to provide for shut-off of the circular-saw by another person in the event of an accident and/or to allow the user to control the power for cutting from either side of the assembly 100. A conventional 3-way single-pole switch may be used to control the power to the outlet 112, although a series connection of 1-way single-pole switches may also be used to provide greater degree of safety, requiring both (or any number of) switches to be turned on before power can be provided to the circular-saw 50.

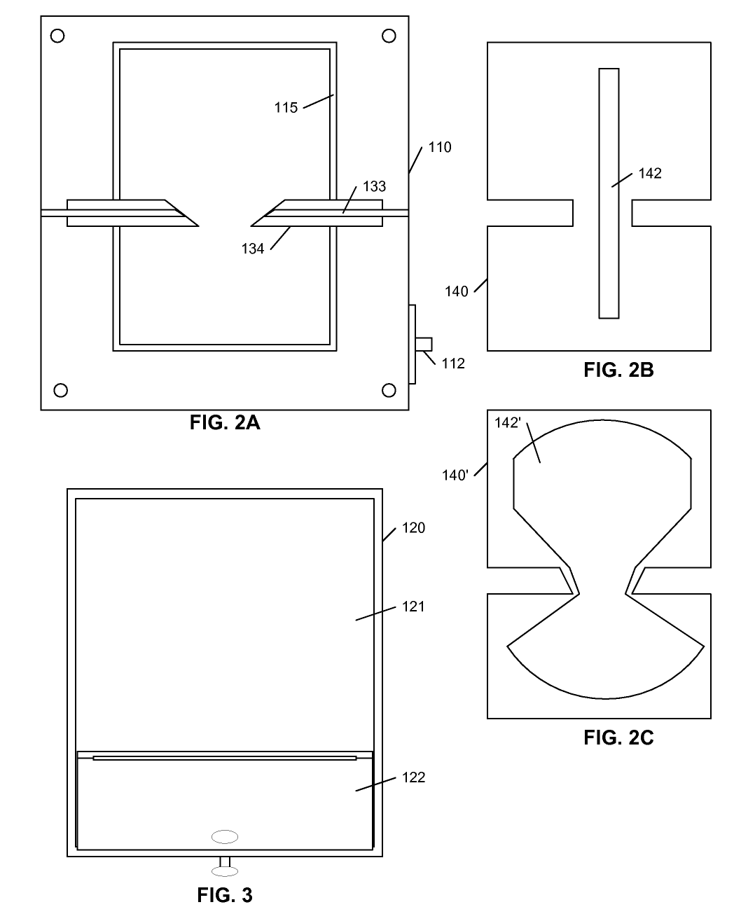

FIG. 2A illustrates a top view of an example embodiment of a base unit 110. In this embodiment, the base unit 110 includes a removable kerf board insert 140, illustrated in FIG. 2B. The insert 140 is supported on a ledge 115 that surrounds an opening in the top surface of the base unit 110.

Cross-cut fence-support units 134 extend as far into the opening as is feasible, allowing the range of miter angles of the saw blade without interference from these fence-support units 134. To allow for compound-miter angles, the fence-support surface may be tapered at the end, allowing for the fence-support 134 to extend as far as possible to provide maximum fence support. The cross-cut fence units 130 of FIG. 1C are preferably snuggly situated in channels 133 on the surface of the base unit 110 at an orientation that is perpendicular to the travel of the saw when the miter angle is 0°, and are removable for rip-cutting.

Example removable inserts 140, 140′ are illustrated in FIGS. 2B, 2C. The insert 140 provides maximum surface support for the most common use of the saw, perpendicular cuts, and rip cuts. A kerf opening 142 allows the kerf of the saw blade to extend below the surface of base unit 110, allowing for through-cuts of the work item. When the assembly 100 is used for other than perpendicular cuts, the insert 140 is removed, the fence-support units 134 being used to support the fence units 130 and the workpiece.

The optional insert 140′ allows for the full range of miter angles of the saw, and need not be removed, but it provides less support for perpendicular cuts of wide workpieces than the insert 140. One of skill in the art will recognize that the figure-8-like opening 142′ illustrated in the insert 140′ may be made directly in the top surface of the base unit 110, eliminating the need to have a removable kerf board.

Of particular note, the structure of the miter assembly of this invention allows the workpiece to be inserted from any of the four directions between the support brackets 155, thereby allowing for rip-cuts. FIG. 1D illustrates top, side, and front views of a rip-cut fence component 180 that provides a fence surface 186 that is parallel to the saw blade when the saw is oriented at the reference location (0°), perpendicular to the front surface. Projections 182 and 183 are configured to assure that the fence surface 186 is perpendicular to the front surface when the securing knob 184 is tightened at the desired width of the rip-cut (distance between the fence surface 186 and the saw blade 11), as illustrated in FIG. 1E.

FIG. 3 illustrates a preferred drawer unit 120 for use in the assembly 100. As illustrated, the drawer is divided into two parts, an open area 121, and a covered area 122. The open area is directly below the kerf opening(s), and will capture the sawdust produced by the cuttings. Having this area in the drawer 120 facilitates the removal of the sawdust after extended use. The covered area 122 is designed to hold small tools and accessories, and includes a hinged cover that provides access to the area when the drawer is extended. Having a cover minimizes the collection of sawdust in this area.

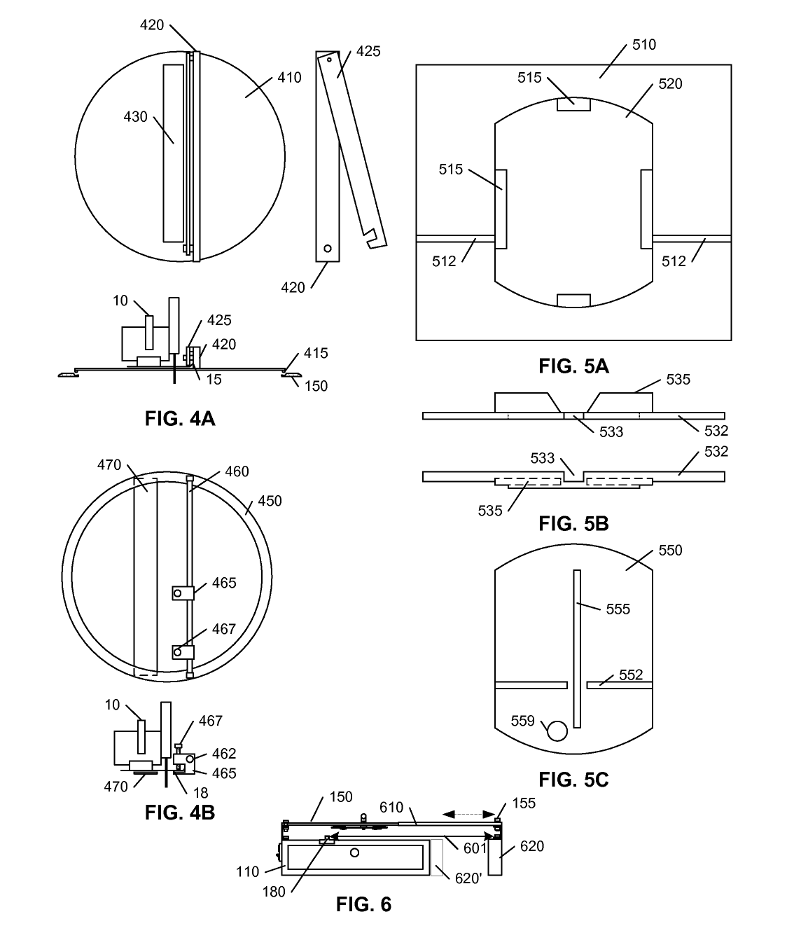

FIGS. 4A and 4B illustrate alternative configurations for the guide assembly. For ease and clarity of illustration, items previously presented, such as the handle assembly for rotating the guide assembly, are omitted from these illustrations.

In 4A, the guide assembly comprises a “lazy-susan” platter 410 with a saw-guide fence 420, and a saw-blade opening 430. At the periphery of the platter 410, bearings 415 are configured to ride in a circular track on the platform 150 (of FIG. 1A). Preferably, some or all of the platter 410 includes a transparent material, such as plexiglass, or cutout areas, to facilitate viewing of the workpiece. In this example embodiment, the user applies side-pressure to the saw 10, to hold the saw-guide 15 against the saw-guide fence 420 as the saw 10 is pushed forward, and the latch element 425 serves to prevent the saw 10 from lifting.

In 4B, the guide assembly comprises lazy-susan ring 450, with a guide-rod 460 and a bearing plate 470. One or more sliding clamps 465 are configured to attach to the guide-plate 18 of the saw 10, to guide the saw along the guide-rod 460, while the weight of the saw is supported on the bearing plate 470, and also serve to prevent the saw 10 from lifting. As in FIG. 4A, the ring 450 may include bearings that ride in a circular track on the platform 150 (not illustrated in FIG. 4B).

Although the rotating assembly is illustrated as a complete platter 410 or ring 450, one of skill in the art will recognize that an arc-segment shape may also be used, similar to the shape formed by the guide rail assembly in FIG. 1A.

FIGS. 5A-5C illustrate an alternative embodiment of a base unit 510 with two general-purpose inserts 530 and 550. The base unit 510 includes an oval-like opening 520, with support elements 515 that are configured to support the inserts 530 and 550. The base unit 510 also includes tracks 512 for receiving a fence.

The insert 530 is provided primarily for miter-cuts, and includes a fence 532 and two workpiece support surfaces 535. The fence 532 is configured to fit within the tracks 512 on the base unit 510, and the support surfaces 535 are configured to rest upon the support elements 515. The fence 532 includes an opening 533, and the support surfaces 535 are tapered to allow the saw blade to travel unimpeded at any miter angle.

The insert 550 is provided primarily for cross-cuts and rip-cuts. The insert 550 is designed to rest on the support elements 515, and provides a surface that supports the workpiece when the workpiece is inserted from either direction. A finger hole 559 facilitates the removal of the insert 550 from the base unit 510 The insert 555 also includes a track 552 that aligns with the track 512 in the base unit and allows for the insertion of fence units (130 of FIG. 1C) when the apparatus is being used for cross-cuts.

FIG. 6 illustrates another alternative embodiment of the miter assembly of this invention wherein the support brackets 155 are coupled to the support platform 150 via a telescoping element 610. In this manner, the width of the workpiece being rip-cut can extend beyond the limits of the base unit, as illustrated by the arrow 601 extending from the rip-fence 180. Preferably, the support element 620 is part of the base unit 110, and is sized so as to provide a support surface for the workpiece. Also preferably, the support element 620 is configured to be fastened to the remainder of the base unit 110 when the extension is not required, as illustrated by the dashed-outline of support element 620′. This fastening can be accomplished using, for example, a latch or a pair of hook-and-eye (Velcro®) strips.

The example illustrations are presented to facilitate understanding of the principles of this invention, and are not intended to limit the range of particular embodiments of this invention. Other enhancements and/or alternatives will be readily apparent to one of skill in the art in view of this invention. For example, to further assure that the rip-cut fence component 180 is positioned perpendicular to the front face of the base unit 110, channels may be configured along the front and rear face of the base unit 110, within which the projections 182 and 183 ride. In such an embodiment, the tightening arrangement 184 can also be configured to apply a friction fit to the outer channel surface, rather than applying tension to the projections 182 and 183.

In like manner, if the guide assembly is configured to allow for a full 90° rotation, the rip-cut fence component may be configured to extend from side-to-side of the base unit 110, instead of front-to-back, to facilitate rip-cutting from the side, by orienting the saw at 90°. Optionally, if the base unit 110 is square, the rip-cut fence can be used in either orientation.

Although the support plate 150 is illustrated with a circular opening, one of skill in the art will recognize that the opening need only provide clearance for a limited miter range, such as ±60 degrees, thereby allowing for a narrower plate 150 and base unit 110. The term “substantially circular opening” as used herein includes such a truncated circular opening, similar to the illustrated openings 520 in FIG. 5 and 142′ in FIG. 2C.

With regard to the base unit 110, although the drawer unit 120 and the insert kerf boards 140, 140′ provide the above identified utility, one of skill in the art will recognize that the base unit could merely be a ½″ to ¾″ thick sheet of plywood, with a replaceable ¼″ sheet of veneer upon which kerf cuts can be made as required by the user, similar to the kerf-veneer arrangement used for conventional radial arm saws. In like manner, the support platform 150 could be marketed as a independent component, relying on the user to provide a suitable work surface. In such an embodiment, the support platform 150 could include a removable fence assembly that extends beneath the platform 150.

One of skill in the art will also recognize that many of the features detailed in the above referenced prior art patents may be included in the miter assembly of this invention. For example, U.S. Pat. No. 4,519,280, cited above, teaches the use of a “keeper” on a track to keep the circular-saw from lifting off the track, as well as the use of holes in the base unit to facilitate clamping of a workpiece or guide, if necessary.

Additionally, one of skill in the art will recognize that although the invention is presented using a conventional rectilinear support platform and base with four support posts, other shapes may be used, and as few as three support posts would be sufficient to support the support platform above the work surface.

The foregoing merely illustrates the principles of the invention. It will thus be appreciated that those skilled in the art will be able to devise various arrangements which, although not explicitly described or shown herein, embody the principles of the invention and are thus the spirit and scope of the following claims. For example, in addition to providing a support assembly for a circular-saw, the miter assembly of this invention also allows for other power tools to be supported and guided, including, for example, a router, a jig-saw, and so on.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts is intended to be required unless specifically indicated; and

i) the term “plurality of” an element includes two or more of the claimed element, and does not imply any particular range of number of elements; that is, a plurality of elements can be as few as two elements, and can include an immeasurable number of elements.

I claim:

1. An apparatus comprising:
a support platform that includes a substantially circular opening,
a guide assembly that is configured to support and guide a circular-saw at a select angle relative to a reference position of the guide assembly on the support platform, and
a plurality of support elements that are configured to support the support platform above a work surface,
wherein the support elements and support platform are arranged to allow a workpiece to be introduced to facilitate either a cross-cut or a rip-cut of the workpiece while the guide assembly is positioned at the reference position, and a miter-cut of the workpiece while the guide assembly is offset from the reference position.

2. The apparatus of claim 1, including a base unit that is configured to provide the work surface.

3. The apparatus of claim 2, wherein the base unit is configured to receive one or more fence units that serve to align the workpiece relative to a blade of the circular-saw.

4. The apparatus of claim 3, including a first fence unit that aligns the workpiece to be perpendicular to the blade of the circular-saw when the guide assembly is in the reference location.

5. The apparatus of claim 4, including a second fence unit that aligns the workpiece to be parallel to the blade of the circular-saw when the guide assembly is in the reference location.

6. The apparatus of claim 2, wherein the base unit includes a drawer that is configured to collect sawdust produced during cutting of the workpiece.

7. The apparatus of claim 6, wherein the drawer includes a partitioned section that is configured to hold small tools or accessories.

8. The apparatus of claim 2, wherein the base unit includes an opening that is configured to receive an insert that is configured to support the workpiece.

9. The apparatus of claim 8, wherein the insert is one of a plurality of inserts, each insert providing a particular kerf pattern.

10. The apparatus of claim 1, including a guide handle assembly that is configured to facilitate adjusting the guide assembly to the select angle, and to maintain the guide assembly at the select angle.

11. The apparatus of claim 1, wherein the support platform includes a curved slot with a plurality of radial slots that are configured to hold the guide assembly at predefined angles.

12. The apparatus of claim 1, wherein the guide assembly includes guide rails that are configured to be adjustable to accommodate a variety of widths of circular-saw sole plates.

13. The apparatus of claim 12, wherein the guide assembly includes one or more elements that are configured to substantially inhibit the circular-saw from lifting while cutting the workpiece.

14. The apparatus of claim 1, including an electric outlet and pigtail plug for coupling the circular-saw to a source of power.

15. The apparatus of claim 14, including one or more switches that allows for decoupling the circular-saw from the source of power.

16. The apparatus of claim 15, wherein at least two switches are provided to allow decoupling of the circular-saw from the source of power from at least two locations.

17. An apparatus comprising:
a substantially rectilinear base unit that is configured to provide a work surface for cutting a workpiece,
a substantially rectilinear support platform that is suspended over the base unit via four support elements arranged at the vertices of the support platform and base unit,
a guide assembly that is configured to support a circular-saw within a substantially circular opening in the support platform, and is rotatable within the opening of the support platform through a variety of angles relative to a reference position of the guide assembly in the support position,
wherein the arrangement of the support elements at the vertices of the base unit allows the workpiece to be introduced between any two of the four support elements, thereby facilitating rip-cuts as well as cross-cuts and miter-cuts.

18. The apparatus of claim 17, wherein the base unit includes an opening with support elements that are configured to support an insert that is selected based on the type of cut being performed on the workpiece.

19. The apparatus of claim 17, wherein the support platform includes one or more clamping screws that are configured to clamp the workpiece to the work surface.

20. The apparatus of claim 17, wherein the base unit includes at least one slot that is arranged to accept at least one fence unit that facilitates orthogonal cross-cuts when the guide assembly is in the reference position.
